(19) United States
(12) Patent Application Publication
(10) Pub. No.: US 2016/0279016 A1
(43) Pub. Date: Sep. 29, 2016

(54) Versatile Body Massager

(71) Applicants: Donald Joseph McDonald, Mulberry, FL (US); Pat Quinto, Lakeland, FL (US)

(72) Inventors: Donald Joseph McDonald, Mulberry, FL (US); Pat Quinto, Lakeland, FL (US)

(21) Appl. No.: 15/081,547

(22) Filed: Mar. 25, 2016

Related U.S. Application Data
(60) Provisional application No. 62/138,738, filed on Mar. 26, 2015.
(60) Provisional application No. 62/165,539, filed on May 22, 2015.

(51) Int. Cl. A61H 7/00; A61H 1/02

(52) U.S. Cl. CPC A61H 7/002; A61H 1/0281

(57) ABSTRACT

A massage device which allows a user to easily and effectively self-administer a neck and/or shoulder massage. The device includes a first crossbar, a first leg assembly, and a second leg assembly. The first crossbar acts as the engagement element. The first leg assembly and the second leg assembly each include a handle, a support bar, and a rocker runner. The handle is collinearly and adjacently connected to the support bar. The rocker runner is adjacently connected to the support bar, opposite the handle, and allows for a rocking motion. The support bar positions and holds the first crossbar and acts as the load-bearing element. The support bar of the first leg assembly is adjacently and perpendicularly connected to the first crossbar. The support bar of the second leg assembly is adjacently and perpendicularly connected to the first crossbar, opposite the support bar of the first leg assembly.

The current application claims a priority to the U.S. Provisional Patent application Ser. No. 62/138,738 filed on Mar. 26, 2015 and the U.S. Provisional Patent application Ser. No. 62/165,539 filed on May 22, 2015.

### FIELD OF THE INVENTION

The present invention relates generally to massage devices. More specifically, the present invention is a massage device for the neck and upper shoulder region that may also be used to stimulate and massage various other body parts such as calf muscles, thighs, and other similar regions. Additionally, the present invention may also be used for rehab, stretching, exercising, and muscle strengthening.

### BACKGROUND OF THE INVENTION

Many people experience tension, aches, injuries, tightening, weakening, and pain in and around their neck and upper shoulders. Those who often suffer from these injuries and physical experiences can typically gain relief from a neck and/or shoulder massage. A massage applies pressure onto the exterior of the skin in order to physically unwind tense muscles, activate specific pressure points, promote blood flow, and promote relaxation and well-being all around. Even those who don't experience much discomfort, would likely still enjoy neck massages as well. The present invention delivers a satisfying deep, and/or soft penetrating tissue massage. The main advantage of the present invention is that any individual can administer a massage entirely by themselves. The present invention is a stand-alone device that does not require batteries or other electrical sources. Additionally, the present invention does not contain mechanical parts that degrade and break over time.

### BRIEF DESCRIPTION OF THE DRAWINGS

FIG. 1 is a perspective view of the present invention.

FIG. 2 is a partially-exploded view of the present invention depicting a removable sheath.

FIG. 3 is a perspective view of the present invention depicting the removable sheath being attached to a first crossbar.

FIG. 4 is a side-view of the removable sheath.

FIG. 5 is a perspective view of an alternative embodiment of the present invention depicting a second crossbar.

FIG. 6 is a front view of the alternative embodiment of the present invention.

FIG. 7 is a cross-sectional view taken about line A-A in FIG. 6.

FIG. 8 is a schematic diagram depicting a cross-section of the first crossbar.

### DETAIL DESCRIPTIONS OF THE INVENTION

All illustrations of the drawings are for the purpose of describing selected versions of the present invention and are not intended to limit the scope of the present invention.

The present invention generally relates to massage devices. More specifically, the present invention is a massage device which allows a user to self-administer a massage to the neck and/or shoulder regions. Additionally, the present invention may also be used for rehab, stretching, exercising, and muscle strengthening. This is achieved through a lie-down massage configuration, where the massage pressure is derived from and based on the weight of the user. In other words, the user lies down onto the present invention in order to administer a deep pressure massage onto the neck and/or the shoulder region. Resultantly, the user is able to vary the intensity of the massage simply by leaning more or less onto the present invention. Additionally, the present invention may be used to massage various other body parts such as calf muscles and thighs.

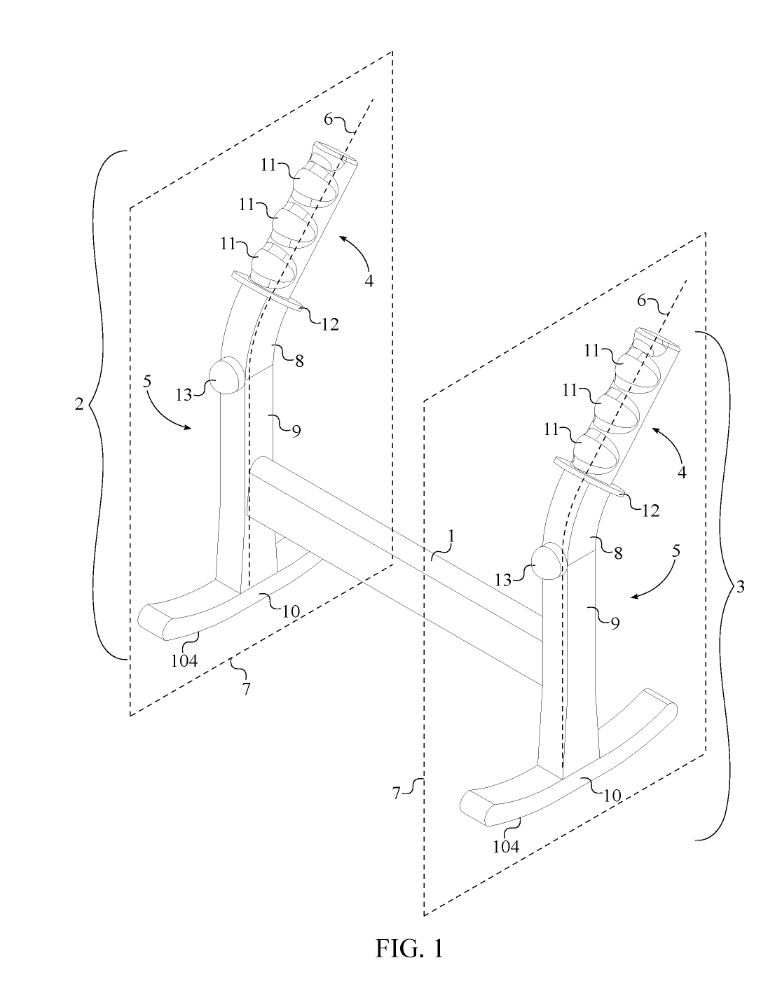

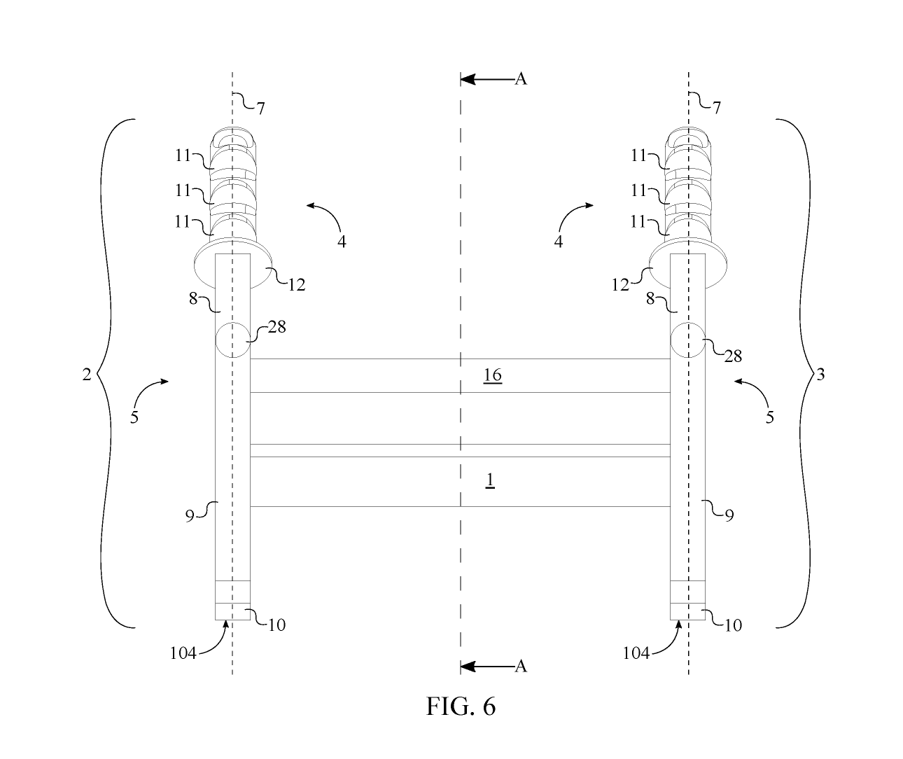

Referring to FIG. 1, the present invention comprises a first crossbar 1, a first leg assembly 2, and a second leg assembly 3. The first crossbar 1 is the structure of the present invention which applies pressure onto the neck and/or shoulder region. The first leg assembly 2 and the second leg assembly 3 vertically position and support the first crossbar 1. The first leg assembly 2 and the second leg assembly 3 each comprise a support bar 5, a rocker runner 10, and a handle 4. The support bar 5 positions and holds the first crossbar 1 at a specific height and acts as the load-bearing element of the present invention. More specifically, the support bar 5 bears the vertical load applied to the first crossbar 1 when the user lies down and rests a portion of his/her body onto the first crossbar 1. The support bar 5 of the first leg assembly 2 is adjacently and perpendicularly connected to the first crossbar 1. Similarly, the support bar 5 of the second leg assembly 3 is adjacently and perpendicularly connected to the first crossbar 1, opposite the support bar 5 of the first leg assembly 2. Additionally, the support bar 5 of the first leg assembly 2 is oriented parallel to the support bar 5 of the second leg assembly 3. This creates an H-shaped design when viewed from a front view as seen in FIG. 6. The handle 4 acts as the grasping element of the present invention. The handle 4 is collinearly and adjacently connected to the support bar 5 and is shaped/sized complimentary to the contours of the human hand.

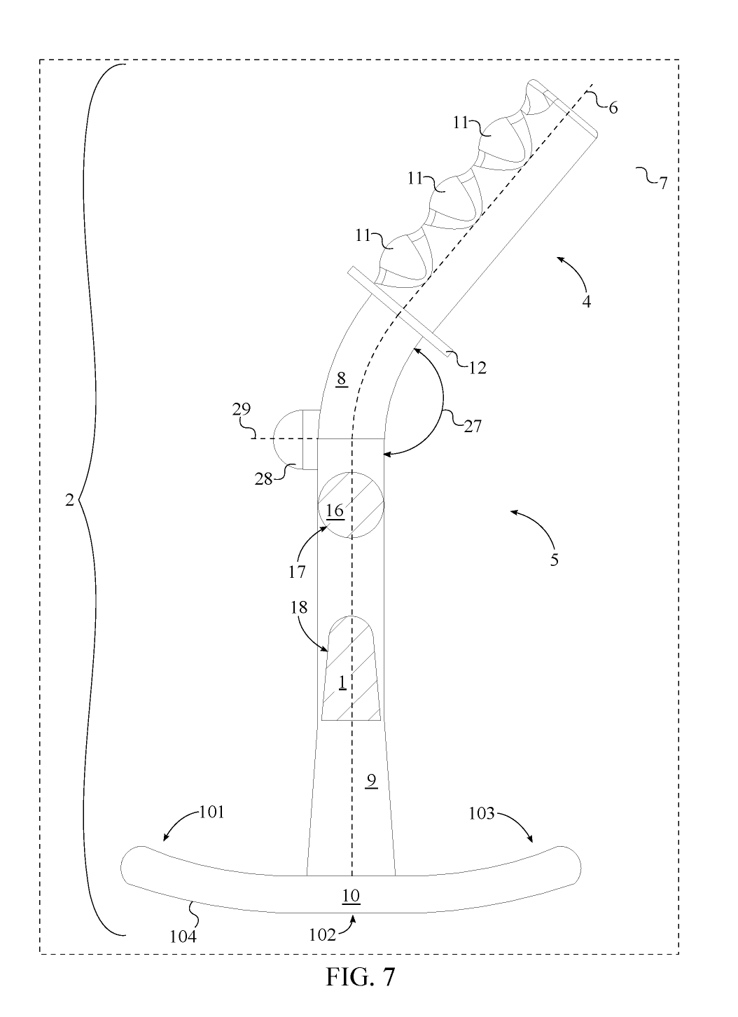

The rocker runner 10 provides vertical stability for the present invention. The rocker runner 10 is preferably an elongated rectangular bar that is permanently bent into a semi-circular shape, similar to the legs of a rocking chair. The rocker runner 10 is adjacently connected to the support bar 5, opposite the handle 4. More specifically, the support bar 5 is adjacently connected to the rocker runner 10, opposite a rocking contact surface 104 of the rocker runner 10. The rocking contact surface 104 is the bottom surface of the rocker runner 10 as the bottom surface comes in direct contact with the floor. Additionally, the rocker runner 10 of the first leg assembly 2 is concentrically positioned with the rocker runner 10 of the second leg assembly 3, resulting in a symmetric configuration as seen in FIG. 1 and FIG. 7. The rocker runner 10 allows the present invention to move in a forward and back rocking motion, similar to a rocking chair. It is preferred that the rocker runner 10 comprises a first curved portion 101, a flat portion 102, and a second curved portion 103. The first curved portion 101 is adjacently connected to the flat portion 102. Similarly, the second curved portion 103 is adjacently connected to the flat portion 102, opposite the first curved portion 101. The flat portion 102 ensures that the present invention stands upright. The first curved portion 101 and the second curved portion 103 allow the present invention to rock forward and backward. The rocking motion allows the user to move the first crossbar 1 up and down along the neck and shoulder region in order to massage a larger area. Additionally, the support bar 5 is perpendicularly connected to the flat portion 102, essentially bisecting the rocker runner 10. This ensures that the present invention stays in a vertical orientation when released and/or placed on the ground. Additionally, this also helps to ensure stability and non-movement in order to facilitate proper placement of the first crossbar 1 onto certain pressure points before starting the massage.

In order to utilize the present invention to massage the neck and shoulder region, the user first lies down on his/her back and positions his/her neck directly onto the first crossbar 1, in between the first leg assembly 2 and the second leg assembly 3. Then, the user grabs the handle 4 of the first leg assembly 2 and the handle 4 of the second leg assembly 3 and slowly lowers his/her upper body further until he/she feels pressure around the neck region. Finally, the user pushes and pulls the handle 4 of the first leg assembly 2 and the handle 4 of the second leg assembly 3 towards and away from his/her body. This motion moves the first crossbar 1 up and down along the back of the user, thus applying a massaging pressure up and down to the back. In order to apply more or less pressure, the user simply varies the degree to which he/she is leaning on the first crossbar 1. The user may also simply strategically position the first crossbar 1 at specific pressure points and not rock the present invention. The present invention may also be used to massage other body parts including, but not limited to, thighs, calves, and arms. The user simply pushes against the first crossbar 1 with the region he/she would like to massage and rocks the present invention forward and backward.

Referring to FIG. 7, the preferred support bar 5 is a rectangular extrusion composed of structural material that is designed to withstand a minimum of 25 pounds. The support bar 5 comprises an upper portion 8 and a lower portion 9. The upper portion 8 is adjacently positioned to the lower portion 9, opposite the rocker runner 10. More specifically, the upper portion 8 is oriented with the lower portion 9 at an obtuse angle 27 in order position the handle 4 at an angled orientation and a more ergonomic placement for the handle 4. The preferred range for the obtuse angle 27 is between 160 degrees and 180 degrees. Furthermore, the handle 4, the lower portion 9, and the upper portion 8 are all positioned coplanar with the rocker runner 10. Referring to FIG. 1, a central axis 6 traverses through and along the upper portion 8, the lower portion 9, and the handle 4. The central axis 6 is coincidentally aligned with a sagittal plane 7 of the rocker runner 10; the sagittal plane 7 is the plane which divides a body into right and left halves. In reference to the present invention, the sagittal plane 7 divides the first leg assembly 2 and the second leg assembly 3 along the length of the body. At the lower extreme of the range for the obtuse angle 27, the handle 4 is oriented and positioned away from the support bar 5. This ensures that the handle 4 of the first leg assembly 2 and the handle 4 of the second leg assembly 3 are more easily accessible to the hands of the user when the present invention is utilized to massage the neck and shoulder regions. In other words, the user is not required to extend his or her hands as much when rocking the present invention forwards and backwards.

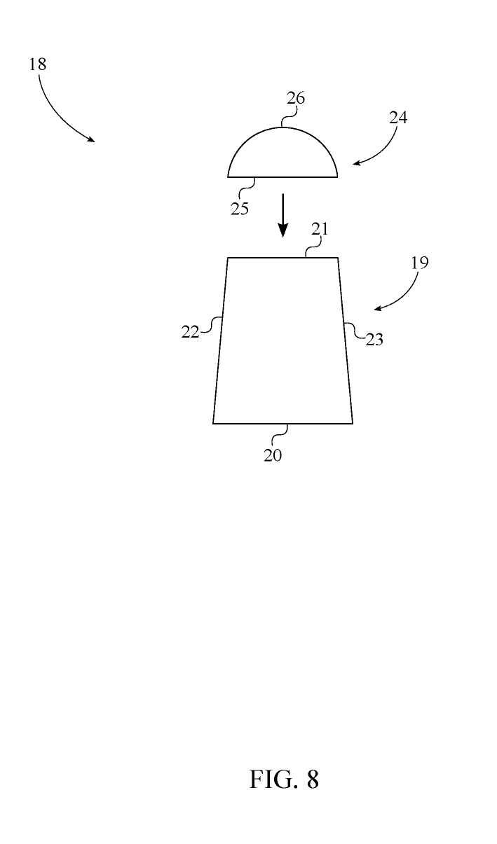

Referring to FIG. 7 and FIG. 8, In the preferred embodiment of the present invention, a cross-section 18 of the first crossbar 1 comprises a trapezoidal portion 19 and a semi-circular portion 24. More specifically, a straight edge 25 of the semi-circular portion 24 is coincidentally positioned with a short base 21 of the trapezoidal portion 19. A first diagonal leg 22 of the trapezoidal portion 19 and a second diagonal leg 23 of the trapezoidal portion 19 are each tangentially positioned to an arch-shaped edge 26 of the semi-circular portion 24. The short base 21 of the trapezoidal section is positioned parallel to a long base 20 of the trapezoidal section. This creates an upside down U-shape with tapered sides and wider base. The semi-circular portion 24 is ideal for creating massage pressure while the tapered aspect of the trapezoidal portion 19 is ideal for receiving attachments to the first crossbar 1, described below.

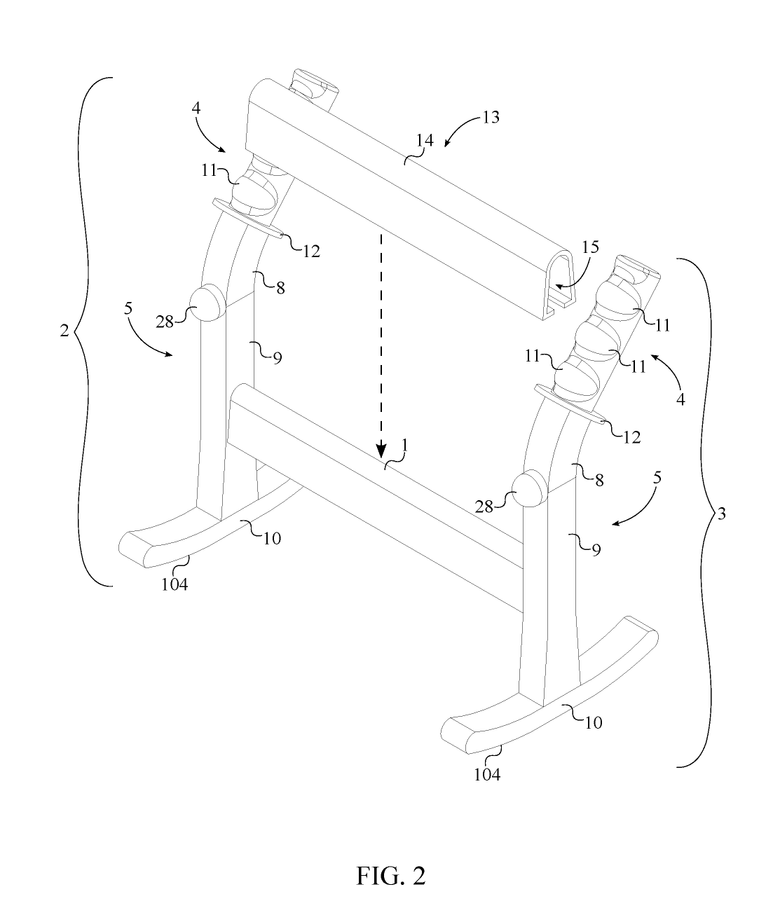

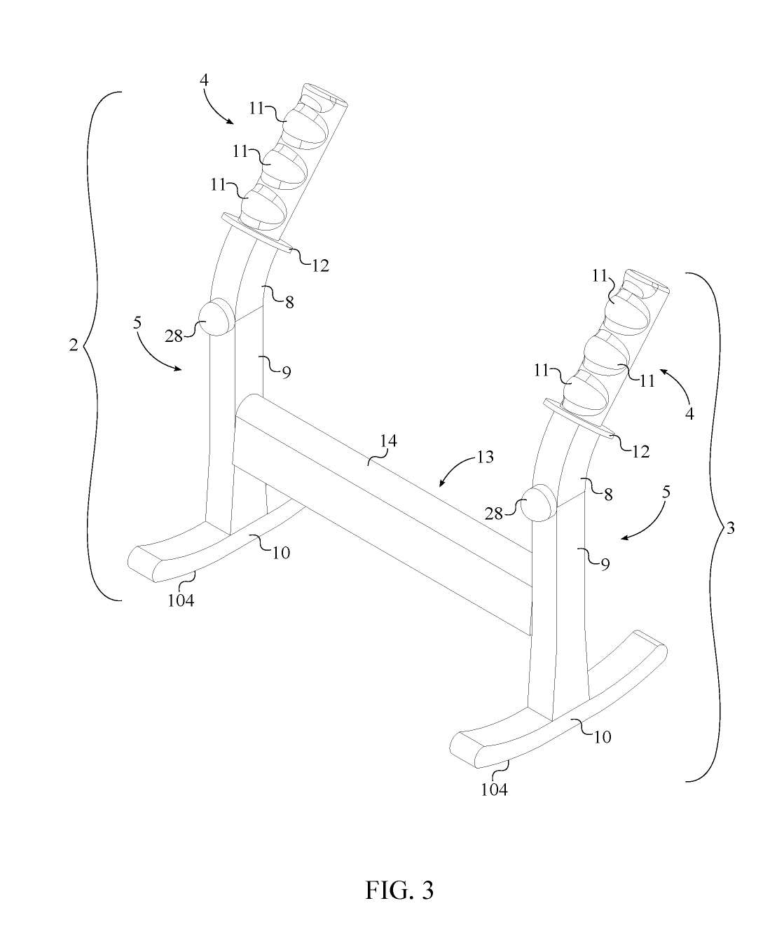

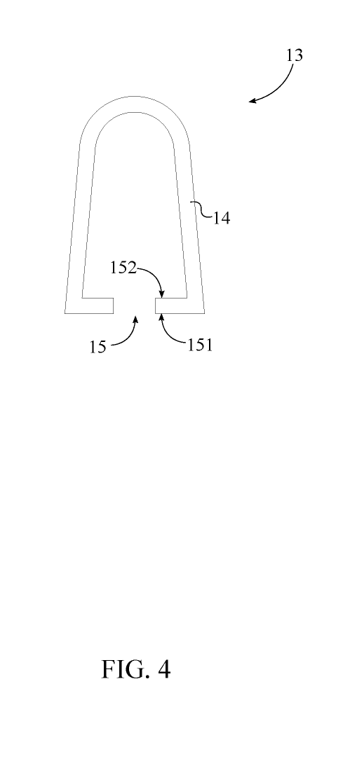

Referring to FIG. 2 through FIG. 5, the present invention may also comprise a removable sheath 13 and a second crossbar 16. The removable sheath 13 is a layer of ridged material that may be attached to the first crossbar 1 to alter the pressure being produced. The removable sheath 13 applies pressure to larger area, resulting in a less penetrating feeling. More specifically, the removable sheath 13 is attached to the first crossbar 1 wherein the removable sheath 13 is encircling the first crossbar 1 as seen in FIG. 3. Additionally, the removable sheath 13 is positioned along the first crossbar 1 from the support bar 5 of the first leg assembly 2 to the support bar 5 of the second leg assembly 3. The removable sheath 13 is designed for massaging regions of the body that are more sensitive. Referring to FIG. 2 and FIG. 4, the removable sheath 13 comprises a tubular body 14 and an expandable slot 15. The tubular body 14 is complimentary shaped to the first crossbar 1 and comprises an outer surface 151 and an inner surface 152. The expandable slot 15 laterally traverses through the tubular body 14 from the outer surface 151 to the inner surface 152. The expandable slot 15 also traverses through and along the tubular body 14 to create a path for slipping the tubular body 14 over the first crossbar 1. In order to attach the removable sheath 13 to the first crossbar 1, the user simply aligns the tubular body 14 parallel to the first crossbar 1 with the expandable slot 15, directly adjacent to the first crossbar 1 as seen in FIG. 3. Then, the user pushes the tubular body 14 onto the first crossbar 1 in order to deform the tubular body 14 and open up the expandable slot 15 as the tubular body 14 encircles the first crossbar 1. The present invention may include different sizes for the removable sheath 13 to allow the user to further customize the type of massage being produced by the present invention. In one embodiment of the present invention, the removable sheath 13 is composed of cushioned material to soften the massage pressure of the present invention.

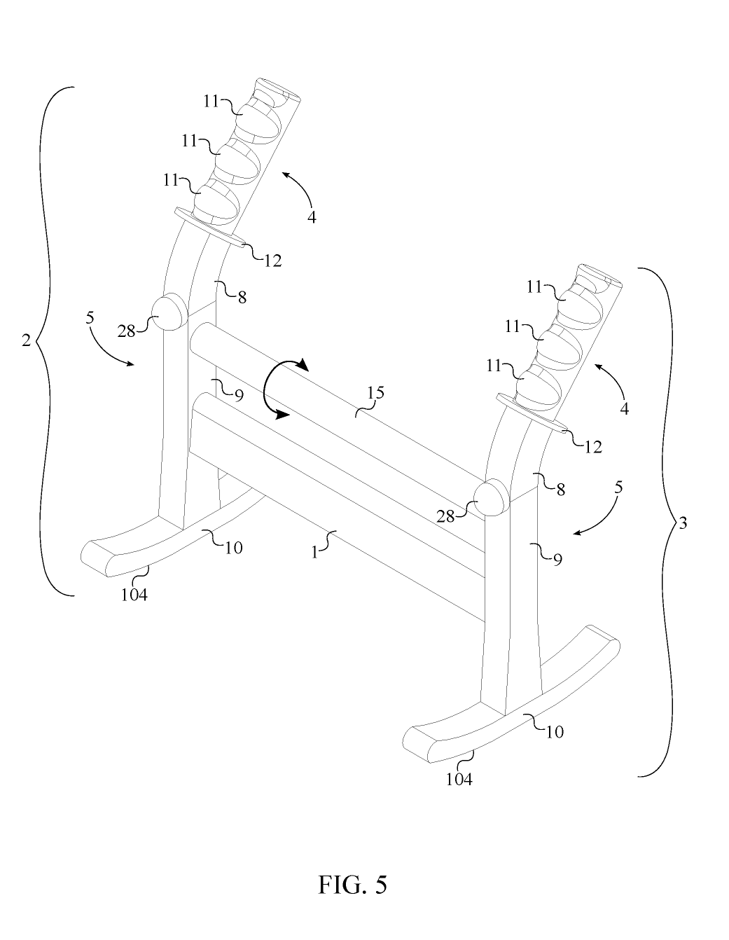

Referring to FIG. 5 and FIG. 6, the second crossbar 16 is another engagement element of the present invention which may be used for massaging purposes. The second crossbar 16 is oriented parallel to the first crossbar 1 and is positioned in between the handle 4 of the first leg assembly 2 and the first crossbar 1. Furthermore, the second crossbar 16 is rotatably mounted in between the support bar 5 of the first leg assembly 2 and the support bar 5 of the second leg assembly 3. This allows the second crossbar 16 to rotate in place, providing smoother and more uniform pressure application when the present invention is rocked forwards and backwards. The second crossbar 16 simulates the pressure produced by typical massage rollers. Therefore, a cross-section 17 of the second crossbar 16 is preferably a circular shape as seen in FIG. 7. In one embodiment of the present invention, the second crossbar 16 is removably attached to the support bar 5 of the first leg assembly 2 and the support bar 5 of the second leg assembly 3, thus allowing the user to pick and choose what type of engagement element to use. Although, alternative shapes and designs may be used for the cross-section 17 of the second crossbar 16 including, but not limited to, oval, square, hexagonal, and rectangular.

Referring to FIG. 1 and FIG. 7, the first leg assembly 2 and the second leg assembly 3 each further comprise a plurality of ergonomic ridges 11, a collar 12, and a nodule 28. The plurality of ergonomic ridges 11 provides engagement contours for the user's hand for a more comfortable and secure grip around the handle 4. The plurality of ergonomic ridges 11 is distributed along the handle 4 with each of the plurality ergonomic ridges being adjacently connected to the handle 4. Each of the plurality of ergonomic ridges 11 is preferably oriented facing away from the rocker runner 10 as seen in FIG. 7. The collar 12 is an annular disk that acts a stop for the handle 4 to prevent accidental slippage of the user's hand during operation. More specifically, the collar 12 is laterally connected around the handle 4, adjacent to the upper portion 8. The nodule 28 is a rounded extrusion which allows the user to apply pressure to one specific point. The nodule 28 is adjacently connected to the support bar 5 in between the first crossbar 1 and the handle 4 with a main axis 29 of the nodule 28 being perpendicularly oriented to the first crossbar 1. To utilize the nodule 28, the user lies down the present invention on its side with the nodule 28 being oriented upwards and lies on top.

Although the invention has been explained in relation to its preferred embodiment, it is to be understood that many other possible modifications and variations can be made without departing from the spirit and scope of the invention as hereinafter claimed.

What is claimed is:

1. A versatile body massager comprises:
a first crossbar;
a first leg assembly;
a second leg assembly;
the first leg assembly and the second leg assembly each comprise a handle, a support bar, and a rocker runner;
the handle being collinearly and adjacently connected to the support bar;
the rocker runner being adjacently connected to the support bar, opposite the handle;
the support bar being adjacently connected to the rocker runner, opposite a rocking contact surface of the rocker runner;
the support bar of the first leg assembly being adjacently and perpendicularly connected to the first crossbar;
the support bar of the second leg assembly being adjacently and perpendicularly connected to the first crossbar, opposite to the support bar of the first leg assembly;
the support bar of the first leg assembly being oriented parallel to the support bar of the second leg assembly; and
the rocker runner of the first leg assembly being concentrically positioned with the rocker runner of the second leg assembly.

2. The versatile body massager as claimed in claim 1 comprises:
the support bar comprises an upper portion and a lower portion;
the upper portion being adjacently positioned to the lower portion, opposite to the rocker runner;
the upper portion being oriented with the lower portion at an obtuse angle;
a central axis traversing through and along the upper portion, the lower portion, and the handle; and
the central axis being coincidentally aligned with a sagittal plane of the rocker runner.

3. The versatile body massager as claimed in claim 1 comprises:
the first leg assembly and the second leg assembly each further comprise a plurality of ergonomic ridges and a collar;
the plurality of ergonomic ridges being distributed along the handle;
each of the plurality of ergonomic ridges being adjacently connected to the handle; and
the collar being laterally connected around the handle, adjacent to an upper portion of the support bar.

4. The versatile body massager as claimed in claim 1 comprises:
the first leg assembly and the second leg assembly each further comprise a nodule;
the nodule being adjacently connected to the support bar in between the first crossbar and the handle; and
a main axis of the nodule being perpendicularly oriented to the first crossbar.

5. The versatile body massager as claimed in claim 1 comprises:
a removable sheath;
the removable sheath encircling the first crossbar; and
the removable sheath being positioned along the first crossbar from the support bar of the first leg assembly to the support bar of the second leg assembly.

6. The versatile body massager as claimed in claim 5 comprises:
the removable sheath comprises a tubular body and an expandable slot;
the tubular body comprises an outer surface and an inner surface;
the expandable slot laterally traversing through the tubular body from the outer surface to the inner surface; and
the expandable slot traversing through and along the tubular body.

7. The versatile body massager as claimed in claim 1 comprises:
a second crossbar;
the second crossbar being oriented parallel to the first crossbar;
the second crossbar being rotatably mounted in between the support bar of the first leg assembly and the support bar of the second leg assembly; and
the second crossbar being positioned in between the handle of the first leg assembly and the first crossbar.

8. The versatile body massager as claimed in claim 7, wherein a cross-section of the second crossbar is a circular shape.

9. The versatile body massager as claimed in claim 1 comprises:
a cross-section of the first crossbar comprises a trapezoidal portion and a semi-circular portion;
a straight edge of the semi-circular portion being coincidentally positioned with a short base of the trapezoidal portion;
a first diagonal leg of the trapezoidal portion being tangentially positioned to an arch-shaped edge of the semi-circular portion;
a second diagonal leg of the trapezoidal portion being tangentially positioned to the arch-shaped edge of the semi-circular portion; and
the short base of the trapezoidal section being positioned parallel to a long base of the trapezoidal section.

10. The versatile body massager as claimed in claim 1 comprises:
the rocker runner comprises a first curved portion, a flat portion, and a second curved portion;
the first curved portion being adjacently connected to the flat portion;
the second curved portion is adjacently connected to the flat portion, opposite the first curved portion; and
the support bar being perpendicularly connected to the flat portion.

11. A versatile body massager comprises:
a first crossbar;
a first leg assembly;
a second leg assembly;
a removable sheath;
the first leg assembly and the second leg assembly each comprise a handle, a support bar, and a rocker runner;
the handle being collinearly and adjacently connected to the support bar;
the rocker runner being adjacently connected to the support bar, opposite the handle;
the support bar being adjacently connected to the rocker runner, opposite a rocking contact surface of the rocker runner;
the support bar of the first leg assembly being adjacently and perpendicularly connected to the first crossbar;
the support bar of the second leg assembly being adjacently and perpendicularly connected to the first crossbar, opposite to the support bar of the first leg assembly;
the support bar of the first leg assembly being oriented parallel to the support bar of the second leg assembly;
the rocker runner of the first leg assembly being concentrically positioned with the rocker runner of the second leg assembly;
the removable sheath encircling the first crossbar; and
the removable sheath being positioned along the first crossbar from the support bar of the first leg assembly to the support bar of the second leg assembly.

12. The versatile body massager as claimed in claim 11 comprises:
the support bar comprises an upper portion and a lower portion;
the upper portion being adjacently positioned to the lower portion, opposite to the rocker runner;
the upper portion being oriented with the lower portion at an obtuse angle;
a central axis traversing through and along the upper portion, the lower portion, and the handle; and
the central axis being coincidentally aligned with a sagittal plane of the rocker runner.

13. The versatile body massager as claimed in claim 11 comprises:
the first leg assembly and the second leg assembly each further comprise a plurality of ergonomic ridges and a collar;
the plurality of ergonomic ridges being distributed along the handle;
each of the plurality of ergonomic ridges being adjacently connected to the handle; and
the collar being laterally connected around the handle, adjacent to an upper portion of the support bar.

14. The versatile body massager as claimed in claim 11 comprises:
the first leg assembly and the second leg assembly each further comprise a nodule;
the nodule being adjacently connected to the support bar in between the first crossbar and the handle; and
a main axis of the nodule being perpendicularly oriented to the first crossbar.

15. The versatile body massager as claimed in claim 11 comprises:
the removable sheath comprises a tubular body and an expandable slot;
the tubular body comprises an outer surface and an inner surface;
the expandable slot laterally traversing through the tubular body from the outer surface to the inner surface; and
the expandable slot traversing through and along the tubular body.

16. The versatile body massager as claimed in claim 11 comprises:
a second crossbar;
the second crossbar being oriented parallel to the first crossbar;
the second crossbar being rotatably mounted in between the support bar of the first leg assembly and the support bar of the second leg assembly; and
the second crossbar being positioned in between the handle of the first leg assembly and the first crossbar.

17. The versatile body massager as claimed in claim 16, wherein a cross-section of the second crossbar is a circular shape.

18. The versatile body massager as claimed in claim 11 comprises:
a cross-section of the first crossbar comprises a trapezoidal portion and a semi-circular portion;
a straight edge of the semi-circular portion being coincidentally positioned with a short base of the trapezoidal portion;
a first diagonal leg of the trapezoidal portion being tangentially positioned to an arch-shaped edge of the semi-circular portion;
a second diagonal leg of the trapezoidal portion being tangentially positioned to the arch-shaped edge of the semi-circular portion; and
the short base of the trapezoidal section being positioned parallel to a long base of the trapezoidal section.

19. The versatile body massager as claimed in claim 11 comprises:
the rocker runner comprises a first curved portion, a flat portion, and a second curved portion;
the first curved portion being adjacently connected to the flat portion;
the second curved portion is adjacently connected to the flat portion, opposite the first curved portion; and
the support bar being perpendicularly connected to the flat portion.
